(19) United States
(12) Patent Application Publication
(10) Pub. No.: US 2023/0250503 A1
(43) Pub. Date: Aug. 10, 2023

(54) METHOD OF MANUFACTURING GRAIN-ORIENTED ELECTRICAL STEEL SHEET AND MANUFACTURING LINE

(71) Applicant: JFE STEEL CORPORATION, Chiyoda-ku, Tokyo (JP)

(72) Inventors: Yukihiro SHINGAKI, Chiyoda-ku, Tokyo (JP); Tetsuya ARAKAWA, Chiyoda-ku, Tokyo (JP); Yusuke SHIMOYAMA, Chiyoda-ku, Tokyo (JP); Ayaka SERA, Chiyoda-ku, Tokyo (JP)

(73) Assignee: JFE STEEL CORPORATION, Chiyoda-ku, Tokyo (JP)

(21) Appl. No.: 18/003,343

(22) PCT Filed: Jun. 28, 2021
(86) PCT No.: PCT/JP2021/024424

§ 371 Date: Dec. 27, 2022

(30) Foreign Application Priority Data
Jun. 30, 2020 (JP) 2020-113544

(51) Int. Cl. C21D 8/12; C22C 38/08; C22C 38/04; C22C 38/02; C21D 9/46

(52) U.S. Cl. CPC C21D 8/1222; C21D 8/1233; C21D 8/1266; C21D 8/1272; C21D 9/46; C22C 38/02; C22C 38/04; C22C 38/08; C21D 2201/05

(57) ABSTRACT

Provided is a method of manufacturing a grain-oriented electrical steel sheet that has a uniform texture all along the longitudinal direction and has small fluctuations in magnetic properties. The method includes subjecting a predetermined hot-rolled and annealed sheet to cold rolling, where at least one time of cold rolling has a total rolling reduction of 80 % or more and is performed by a tandem mill, rolling performed in at least one stand of the tandem mill is performed under conditions of a rolling reduction of 30 % or more and a biting temperature To °C of a work roll of the stand, and a temperature at which either or both of a leading end and a tail end of the hot-rolled and annealed sheet are bitten by the work roll is 70° C. or higher and at least 10° C. higher than the temperature To °C.

### TECHNICAL FIELD

This disclosure relates to a method of manufacturing a grain-oriented electrical steel sheet and a manufacturing line.

### BACKGROUND

A grain-oriented electrical steel sheet is a steel sheet that has excellent magnetic properties and has a crystallized microstructure (Goss orientation) in which the <001> orientation, which is an easy magnetization axis of iron, is highly concentrated in the rolling direction of the steel sheet.

To achieve such high degree of preferred orientation, JP S50-16610 A (PTL 1) proposes a method of subjecting a steel sheet to heat treatment (aging treatment) at low temperatures during cold rolling, for example.

JP H08-253816 A (PTL 2) describes a technique of setting the cooling rate during annealing before hot-rolled sheet annealing or finish cold rolling (final cold rolling) to 30° C./s or more and further performing twice or more inter-pass aging treatment for two minutes or longer at a steel sheet temperature of 150° C. to 300° C. during finish cold rolling.

JP H01-215925 A (PTL 3) proposes a method of raising the steel sheet temperature to high temperatures during cold rolling (warm rolling).

These techniques keep the steel sheet at an appropriate temperature during cold rolling or in time interval between passes of cold rolling to adhere solute elements, such as carbon C and nitrogen N, on dislocations introduced by rolling, suppress dislocation movement, and cause shear deformation to improve a texture obtained by rolling. The application of these techniques generally reduces a (111) fiber-like structure called y fiber ({111}<112>) in a primary recrystallized texture after cold rolling, thereby obtaining an effect of increasing the presence frequency of the Goss orientation. Such a grain-oriented electrical steel sheet is produced with a method in which Si is set to 4.5 mass% or less, inhibitors such as MnS, MnSe and AlN are formed in a chemical system, and the inhibitors are used to develop secondary recrystallization.

On the other hand, JP 2000-129356 A (PTL 4) proposes a technique (inhibitor-less technique) that can cause secondary recrystallization without inhibitor-forming components.

### CITATION LIST

### Patent Literature

PTL 1: JP S50-16610 A
PTL 2: JP H08-253816 A
PTL 3: JP H01-215925 A
PTL 4: JP 2000-129356 A

### SUMMARY

### Technical Problem

This inhibitor-less method utilizes highly purified steel and develops secondary recrystallization by controlling the texture. This method eliminates the need for high-temperature steel slab heating and enables low-cost manufacturing. On the other hand, because there is no inhibitor to promote secondary recrystallization, more delicate control is required to form the texture. Especially in a manufacturing method involving rolling under high pressure with a rolling reduction of 30 % or more per pass, the properties may be significantly affected by different conditions of the rolling process.

Further, hot rolling is generally performed in units of slabs cast in steelmaking. Therefore, in hot rolling, the leading end side is rolled without tension applied thereon during the rolling, and the rolling speed is usually slow. On the other hand, the rolling speed at the tail end side can be maintained at the same level as that of a central part in the longitudinal direction, but a non-rectangular shape called a fishtail is formed at the tail end side. Further, since the tail end side spends a long time waiting in rolling, the temperature may drop during the waiting period. For this reason, when a coil after hot rolling (hot-rolled coil) is observed by units of coils, portions corresponding to the leading and tail ends are unstationary portions (normally, it refers to a portion corresponding to about less than 5 % from each of the leading end and the tail end of the hot-rolled coil when the total length in the longitudinal direction of the hot-rolled coil is taken as 100 %), and compared to a stationary portion (normally, it refers to a portion corresponding to about 5 % to 95 % from the leading end of the hot-rolled coil when the total length in the longitudinal direction of the hot-rolled coil is taken as 100 %) including a central part in the longitudinal direction, a structure that is not necessarily favorable for texture formation, such as an increase in α fiber (<110> fiber-like structure) that is difficult to recrystallize, is formed in the unstationary portions.

On the other hand, in processes other than hot rolling, coils are usually welded together at the entry side of a process so that the coils pass through the process continuously. Therefore, the same processing is applied in the longitudinal direction of the coil. As a result, the differences in texture between the unstationary portion and the stationary portion caused by hot rolling remain, which may lead to deterioration of magnetic properties in the unstationary portion.

The differences between the unstationary portion and the stationary portion can be gradually reduced by increasing the number of processes, such as performing intermediate annealing or performing rolling twice. However, when the structure is formed by rolling once without intermediate annealing, the deterioration of magnetic properties in the unstationary portion is inevitable. Even if intermediate annealing is performed, the magnetic properties may deteriorate when the total rolling reduction is 80 % or more for one time of cold rolling during the multiple times of cold rolling, because the structure is essentially formed by that time of cold rolling. These tendencies are remarkable when rolling with a rolling reduction of 30 % or more in a single pass is included.

Further, when comparing a case of using a reverse mill for cold rolling and a case of using a tandem mill for cold rolling, deterioration in magnetic properties is often observed in the latter case. The reason is as follows. A reverse mill is not a continuous line and applies processing in units of coils. As a result, an unstationary portion becomes an unpressurized portion (a portion that is wrapped around reels on both sides and cannot be rolled) and is finally removed. On the other hand, a tandem mill is a continuous line and applies uniform processing in the longitudinal direction of a coil, which can be used for processing unstationary portions. However, as described above, the magnetic properties are likely to deteriorate in these portions.

It could thus be helpful to provide a method of manufacturing a grain-oriented electrical steel sheet that has a uniform texture all along the longitudinal direction and has small fluctuations in magnetic properties when the steel sheet is observed in units of hot-rolled coils, as well as a manufacturing line that can be used for the method.

### Solution to Problem

We have completed the present disclosure based on the finding that, by subjecting an unstationary portion of a hot-rolled coil unit to specified heat treatment in a tandem mill, it is possible to form a good texture all along the longitudinal direction and reduce fluctuations in magnetic properties in a grain-oriented electrical steel sheet.

We thus provide the following.

A method of manufacturing a grain-oriented electrical steel sheet, comprising
preparing a steel slab comprising a chemical composition containing (consisting of), in mass%,
C: 0.01 % to 0.10 %,
Si: 2.0 % to 4.5 %,
Mn: 0.01 % to 0.5 %,
Al: less than 0.0100 %,
S: 0.0070 % or less,
Se: 0.0070 % or less,
N: 0.0050 % or less, and
O: 0.0050 % or less,
with the balance being Fe and inevitable impurities,
subjecting the steel slab to hot rolling to obtain a hot-rolled sheet, subjecting the hot-rolled sheet to annealing to obtain a hot band-annealed sheet, subjecting the hot band-annealed sheet to cold rolling once or twice or more with intermediate annealing performed therebetween to obtain a cold-rolled sheet with a final sheet thickness, and subjecting the cold-rolled sheet to primary recrystallization annealing and secondary recrystallization annealing, wherein
at least one time of cold rolling has a total rolling reduction of 80 % or more and is performed by a tandem mill,
rolling performed in at least one stand of the tandem mill is performed under conditions of a rolling reduction of 30 % or more and a biting temperature T₀ °C of a work roll of the stand, and
a temperature at which either or both of a leading end and a tail end of the hot band-annealed sheet are bitten by the work roll is 70° C. or higher and at least 10° C. higher than the T₀ °C.

The method of manufacturing a grain-oriented electrical steel sheet according to [1], wherein a temperature at which either or both of a leading end and a tail end of the hot band-annealed sheet are bitten by the work roll is 120° C. or higher and at least 20° C. higher than the T₀ °C.

The method of manufacturing a grain-oriented electrical steel sheet according to [1] or [2], wherein the at least one stand is a first stand of the tandem mill.

The method of manufacturing a grain-oriented electrical steel sheet according to any one of [1] to [3], wherein rolling performed in at least one stand of the tandem mill is performed at a strain rate of 65 s⁻¹ or more, and either or both of a leading end and a tail end of the hot band-annealed sheet are rolled at a strain rate of less than 65 s⁻¹.

The method of manufacturing a grain-oriented electrical steel sheet according to any one of [1] to [4], wherein the steel slab further contains, in mass%, at least one selected from the group consisting of
Ni: 0.005 % to 1.50 %,
Sn: 0.01 % to 0.50 %,
Sb: 0.005 % to 0.50 %,
Cu: 0.01 % to 0.50 %,
Mo: 0.01 % to 0.50 %,
P: 0.0050 % to 0.50 %,
Cr: 0.01 % to 1.50 %,
Nb: 0.0005 % to 0.0200 %,
B: 0.0005 % to 0.0200 %, and
Bi: 0.0005 % to 0.0200 %.

A manufacturing line comprising a heating device and a tandem mill, wherein
the manufacturing line further comprises a detection device that detects a position in a longitudinal direction of a steel sheet and a control unit of the heating device, and
the control unit controls the heating device based on an output from the detection device to adjust a biting temperature of a work roll of at least one stand of the tandem mill.

The manufacturing line according to [6], wherein the heating device utilizes any one of induction heating, electrical resistance heating, or infrared heating.

### Advantageous Effect

According to the present disclosure, it is possible to provide a method of manufacturing a grain-oriented electrical steel sheet that has a uniform texture all along the longitudinal direction and has small fluctuations in magnetic properties when the steel sheet is observed in units of hot-rolled coils, as well as a manufacturing line that can be used for the method.

### BRIEF DESCRIPTION OF THE DRAWINGS

In the accompanying drawings:

FIG. 1 is a chart illustrating the relationship between the strain rate in the first stand of the tandem mill of Example 1 and the biting temperature of a work roll of the stand.

### DETAILED DESCRIPTION

### Steel Slab

A steel slab used in the manufacturing method of the present disclosure can be manufactured with any known manufacturing method, such as steelmaking and continuous casting, and ingot casting and blooming.

The chemical composition of the steel slab is as follows. As used herein, “%” of each component is a mass percentage unless otherwise specified.

### C: 0.01 % to 0.10 %

C is an essential element for improving a texture obtained by rolling. When the content is less than 0.01 %, the amount of fine carbide required to improve the texture is too small to provide sufficient effects. When the content is more than 0.10 %, it is difficult to perform decarbonization.

### Si:2.0 % to 4.5 %

Si is an element that improves iron loss properties by increasing electric resistance. When the content is less than 2.0 %, the effect is insufficient. When the content is more than 4.5 %, it is extremely difficult to perform cold rolling.

### Mn: 0.01 % to 0.5 %

Mn is a useful element for improving hot workability. When the content is less than 0.01 %, the effect is insufficient. When the content is more than 0.5 %, the primary recrystallized texture is deteriorated, rendering it difficult to obtain secondary recrystallized grains highly concentrated in the Goss orientation.

Al: less than 0.0100 %, S: 0.0070 % or less, Se: 0.0070 % or less

The manufacturing method of the present disclosure is an inhibitor-less method, in which Al, S, and Se, which are inhibitor-forming elements, are suppressed to A1: less than 0.0100 %, S: 0.0070 % or less, Se: 0.0070 % or less, respectively. When Al, S, and Se are excessively added, AlN, MnS, MnSe and the like coarsened by steel slab heating deteriorate the uniformity of the primary recrystallized texture, rendering secondary recrystallization difficult. The content of Al, S, and Se is preferably Al: 0.0050 % or less, S: 0.0050 % or less, and Se: 0.0050 % or less, respectively. The content of Al, S, and Se may be 0 %, respectively.

### N: 0.0050 % or Less

N is suppressed to 0.0050 % or less to prevent its action as an inhibitor and to prevent the formation of Si nitrides after purification annealing. The content of N may be 0 %.

### O: 0.0050 % or Less

O is sometimes an inhibitor-forming element, and an amount of more than 0.0050 % renders secondary recrystallization difficult due to coarse oxides. Therefore, the content is suppressed to 0.0050 % or less. The content of O may be 0 %.

The essential components and inhibiting components of the steel slab have been described above. Further, the steel slab can appropriately contain at least one selected from the following elements.

### Ni: 0.005 % to 1.50 %

Ni serves to increase the uniformity of the microstructure of a hot rolled sheet and improves the magnetic properties. When Ni is contained, the content may be 0.005 % or more from the viewpoint of obtaining sufficient effects, and the content may be 1.50 % or less to avoid deterioration of magnetic properties due to instability of secondary recrystallization.

Sn: 0.01 % to 0.50 %, Sb: 0.005 % to 0.50 %, Cu: 0.01 % to 0.50 %, Mo: 0.01 % to 0.50 %, P: 0.0050 % to 0.50 %, Cr: 0.01 % to 1.50 %, Nb: 0.0005 % to 0.0200 %, B: 0.0005 % to 0.0200 %, and Bi: 0.0005 % to 0.0200 %

All of these elements contribute effectively to the improvement of iron loss properties. In addition to containing these elements, it is possible to contain each component in an amount of the lower limit or more from the viewpoint of obtaining sufficient effects, and it is possible to contain each component in an amount of the upper limit or less from the viewpoint of sufficient development of secondary recrystallized grains. Among these elements, Sn, Sb, Cu, Nb, B and Bi are elements that are sometimes considered as auxiliary inhibitors and are preferably not contained above the upper limit.

The balance of the chemical composition of the steel slab is Fe and inevitable impurities.

### Manufacturing Process

The manufacturing method of the present disclosure includes subjecting a steel slab with the above-described chemical composition to hot rolling to obtain a hot-rolled sheet, subjecting the hot-rolled sheet to annealing to obtain a hot band-annealed sheet, subjecting the hot band-annealed sheet to cold rolling once or twice or more with intermediate annealing performed therebetween to obtain a cold-rolled sheet with a final sheet thickness, and subjecting the cold-rolled sheet to primary recrystallization annealing and secondary recrystallization annealing. Pickling may be performed before cold rolling.

A steel slab with the above-described chemical composition is subjected to hot rolling to obtain a hot-rolled sheet. The steel slab may be subjected to hot rolling after being heated to a temperature of, for example, 1050° C. or higher and lower than 1300° C. Because inhibitor components are suppressed in the steel slab of the present disclosure, there is no need to perform a high temperature treatment of 1300° C. or higher to completely dissolve inhibitor components. Heating to 1300° C. or higher may lead to a too large crystallized microstructure and cause defects called scabs. Therefore, it is preferable to heat the steel slab to lower than 1300° C. From the viewpoint of smooth rolling of the steel slab, it is preferable to heat the steel slab to 1050° C. or higher.

Other hot rolling conditions are not particularly limited, and known conditions can be applied.

The obtained hot-rolled sheet is annealed to obtain a hot band-annealed sheet. At this time, the annealing conditions are not particularly limited, and known conditions can be applied.

The obtained hot band-annealed sheet is subjected to cold rolling. The cold rolling may be performed once or performed twice or more with intermediate annealing performed therebetween. In the manufacturing method of the present disclosure, the total rolling reduction is 80 % or more in at least one time of cold rolling, and it is performed by a tandem mill. The rolling with a total rolling reduction of 80 % or more is advantageous in that it can increase the degrees of accumulation of a texture and provide a microstructure favorable to magnetic properties, but it tends to cause large differences in texture between a stationary portion and an unstationary portion. The manufacturing method of the present disclosure includes such rolling. The total rolling reduction is preferably 95 % or less for the purpose of obtaining the {110}<001> oriented structure necessary for secondary recrystallization.

Conditions such as the rolling reduction of each stand of the tandem mill and the steel sheet temperature are set according to the desired steel sheet properties, volume of manufacture, and the like. In the manufacturing method of the present disclosure, rolling performed in at least one stand is performed under conditions of a rolling reduction of 30 % or more and a biting temperature T₀ °C of a work roll of the stand. In the following description, a stand that adopts the above conditions is also referred to as a predetermined stand.

The rolling reduction at the predetermined stand is not particularly limited if it is 30 % or more. It is preferably 32 % or more. Further, it is less than 55 %. It is preferably 50 % or less. When the rolling reduction of a single stand is higher than usual as described above, the present disclosure can ensure that the product has a uniform texture all along the longitudinal direction and the variation in magnetic properties can be reduced.

The biting temperature T₀ °C of a work roll of the predetermined stand is not particularly limited, and it may be, for example, 30° C. or higher. When the predetermined stand is a stand corresponding to the first pass of rolling, T₀ °C may be around room temperature (25° C.), and it may be slightly higher than room temperature, preferably 45° C. or higher, because rolling using a lubricating oil has increased lubricating ability, for example. A temperature rise due to contact heat transfer by supplying a heated lubricating oil (such as a lubricating oil heated to 45° C. to 70° C.) to the steel sheet may be used to adjust the temperature, for example. On the other hand, T₀ °C may be 120° C. or lower to make a difference from heat treatment performed in the unstationary portion. It is preferably 100° C. or lower. It is more preferably 90° C. or lower.

Warm rolling is known as a method to improve the texture. In normal warm rolling, low-temperature heat treatment (aging) is often performed between passes (after rolling and before the next rolling) by utilizing the rise in steel sheet temperature caused by heat generated during rolling. However, this method cannot distinguish between a stationary portion and an unstationary portion, and heat treatment is performed in the same way along the longitudinal direction of a coil so that the texture cannot be homogenized.

In contrast, in the manufacturing method of the present disclosure, rolling of a stationary portion is in principle performed under the conditions described above, but either or both of a temperature (T₁ °C) at which the leading end of the hot band-annealed sheet is bitten by a work roll and a temperature (T₂ °C) at which the tail end of the hot band-annealed sheet is bitten by a work roll, preferably both, are exceptionally set to 70° C. or higher and 10° C. higher than T₀ °C. As a result, a stationary portion and an unstationary portion are distinguished, and the differences in texture between the stationary portion and the unstationary portion are reduced.

When either or both of T₁ °C and T₂ °C are lower than 70° C., the effects of the heat treatment cannot be sufficiently obtained. Therefore, either or both of T₁ °C and T₂ °C are 70° C. or higher. Either or both of T₁ °C and T₂ °C are preferably 120° C. or higher. Further, T₁ °C and T₂ °C may be 280° C. or lower. They are preferably 250° C. or lower. Within this range, even when a lubricating oil is used for rolling, for example, the viscosity of the lubricating oil can be appropriately maintained.

When the temperature difference between either or both of T₁ °C and T₂ °C and T₀ °C is less than 10° C., it is difficult to reduce the differences in texture. Therefore, the temperature difference is 10° C. or more. The temperature difference is preferably 20° C. or more. Further, the temperature difference may be 150° C. or less. The temperature difference is preferably 100° C. or less. Normally, properties guaranteed as a coil are represented by the worst properties in the coil. Therefore, the difference in properties between the leading and the tailing part of the coil affects the evaluation of quality. The present disclosure intends to homogenize the structure all along a coil, so that the coil can be used as it is without cutting because of its uniform structure. From this point of view, it is not preferable to provide an excessively large temperature difference. The temperature difference may be 150° C. or less. The temperature difference is preferably 100° C. or less.

The predetermined stand may be one, two or more, or any of a plurality of stands contained in the tandem mill, but it is advantageously the first stand. This is because controlling the biting temperature of a work roll of the first stand has an effect that persists during rolling in subsequent stands, thereby obtaining good effects of the heat treatment.

The biting temperature of a work roll of the predetermined stand can be controlled by combining a tandem mill and a heating device and changing the heating performed by the heating device according to the position in the longitudinal direction of a coil when the coil is passed.

For example, the output of the heating device may be increased at either or both of the leading end and the tail end in the longitudinal direction of the coil to increase the biting temperature, and the output may be reduced (including turning off the output) at other locations. In a case where the ends of a hot-rolled coil are cut and removed in a previous process, the control of the heating device in the present application may be avoided even for the coil ends.

The heating method of the heating device is not particularly limited. To vary the biting temperature according to the position in the longitudinal direction, it is preferable to heat the coil directly and in a short period of time when the coil is passed, and heating methods such as induction heating, electrical resistance heating, and infrared heating are preferred because they can raise the temperature in a short period of time.

A detection device that detects the position in the longitudinal direction of the coil and a control unit of the heating device may be further combined, and the biting temperature of a work roll of the predetermined stand heated by the heating device may be adjusted by the control device of the heating device based on the output from the detection device (information of position in the longitudinal direction).

Further, in the predetermined stand, performing rolling while reducing the strain rate in the unstationary portion is advantageous in reducing the differences in texture between the stationary portion and the unstationary portion. For example, when the strain rate of the predetermined stand is set to 65 s⁻¹ or more, rolling is performed at a strain rate of 65 s⁻¹ in the stationary portion, and rolling is performed while reducing the strain rate to less than 65 s⁻¹ exceptionally at either or both of the leading end and the tail end of the hot band-annealed sheet.

As used herein, the strain rate ε can be calculated using Ekelund’s formula,

$$\dot{ε} ≒ \frac{{υ}_{\text{R}}}{\sqrt{{\text{R}}^{′}} {\text{h}}_{1}} \frac{2}{2 \text{- r}} ⋅ \sqrt{\text{r}}$$

(where v_{R} is the roll peripheral speed (mm/s), R′ is the roll radius (mm),

h₁ is the sheet thickness (mm) at the roll entry side, and r is the rolling reduction (%).)

The strain rate can be adjusted by changing, for example, the diameter of a roll and the sheet passing speed during rolling (roll peripheral speed). For example, by decreasing the strain rate and increasing the residence time in the heating device, the biting temperature can be easily increased, which is useful when the capacity of the heating device is insufficient. Further, according to JP 2012-184497 A, at a stage where the total rolling reduction is 50 % or less, decreasing the strain rate can provide the same effect as warm rolling, which can reduce the burden of heat treatment performed by the heating device.

The obtained cold-rolled sheet with a final sheet thickness (also referred to as “final cold-rolled sheet”) is subjected to primary recrystallization annealing and secondary recrystallization annealing to obtain a grain-oriented electrical steel sheet. After subjecting the final cold-rolled sheet to primary recrystallization annealing, the steel sheet may be applied with an annealing separator on its surface and then subjected to secondary recrystallization annealing.

The primary recrystallization annealing is not particularly limited and can be performed with a known method. The annealing separator is not particularly limited, and a known annealing separator can be used. For example, water slurry that is mainly composed of magnesia and added with additives such as TiO₂ as needed can be used. Annealing separators containing silica, alumina and the like can also be used.

The secondary recrystallization annealing is not particularly limited and can be performed with a known method. When a separator mainly composed of magnesia is used, a coating mainly composed of forsterite is formed along with secondary recrystallization. If a coating mainly composed of forsterite is not formed after secondary recrystallization annealing, additional processes such as forming a new coating or smoothing the surface may be performed. When forming an insulating coating with tension, the type of the insulating coating is not particularly limited, and any known insulating coating can be used. A method of applying a coating solution containing phosphate-chromic acid-colloidal silica to the steel sheet and baking the steel sheet at about 800° C. can be suitably used. These methods can be referred to, for example, JP S50-79442 A and JP S48-39338 A. Flattening annealing may be performed to shape the steel sheet, and flattening annealing may also serve as baking of the insulating coating.

### EXAMPLES

### Example 1

A steel slab containing, in mass%, C: 0.04 %, Si: 3.2 %, Mn: 0.05 %, A1: 0.005 %, Sb: 0.01 %, and S, Se, N and O each in a reduced amount of 50 ppm or less, with the balance being Fe and inevitable impurities, was heated to 1150° C., subjected to hot rolling to obtain a 2.0 mm hot-rolled coil, and then subjected to hot-rolled sheet annealing at 1035° C. for 40 seconds. Next, the sheet was subjected to cold rolling to obtain a cold-rolled sheet with a thickness of 0.23 mm.

In the cold rolling, a tandem mill (with a roll diameter of 410 mmφ and 4 stands) in which an induction heating device was placed immediately before the entry side of a first pass of the mill was used, the rolling speed was reduced at locations equivalent to the leading end and the tail end of the coil, and the induction heating device was simultaneously used to control the biting temperature of a work roll of the first stand of the mill.

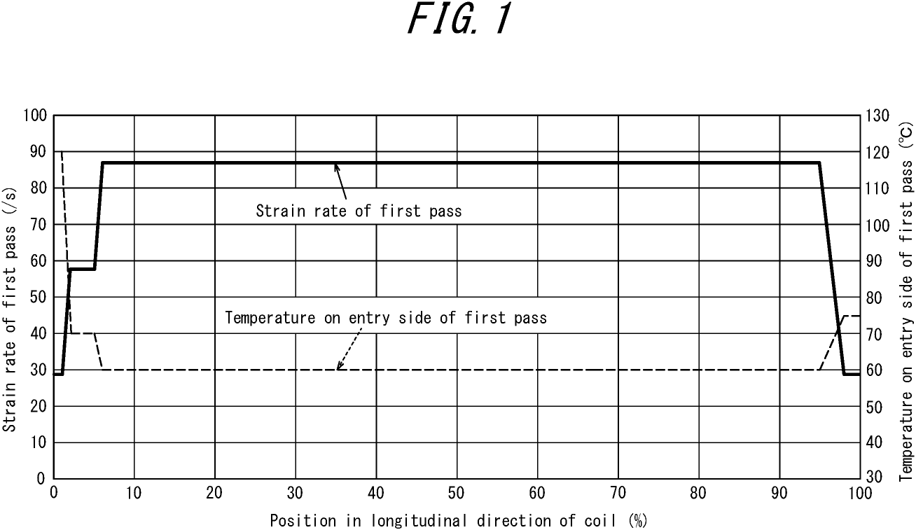

FIG. 1 illustrates the variation in the strain rate in the first stand of the tandem mill and the biting temperature of a work roll of the stand. The horizontal axis represents the distance from the leading end of the coil, where the leading end is 0 %, and the tail end is 100 %.

Specific controls are as follows.

The biting temperature of the leading end of the coil was controlled at 120° C., and rolling was performed at a strain rate of 29 s⁻¹.

Next, after a stage of a biting temperature of 70° C. and a strain rate of 58 s⁻¹, rolling was performed at a biting temperature of 60° C. and a strain rate of 87 s⁻¹ in a stationary portion in a range of more than 5 % and less than 95 % of the length in the longitudinal direction of the coil.

The biting temperature of the tail end of the coil was controlled at 75° C., and rolling was performed at a strain rate of 29 s⁻¹.

The obtained cold-rolled sheet was subjected to primary recrystallization annealing at a soaking temperature of 800° C. for a soaking time of 120 seconds.

The obtained sheet after primary recrystallization annealing was applied with an annealing separator mainly composed of MgO and subjected to secondary recrystallization annealing at a soaking temperature of 1150° C. for a soaking time of 7 hours.

The obtained sheet after secondary recrystallization annealing was applied with a coating solution containing phosphate and chromic acid and subjected to stress relief annealing at 850° C. for 50 seconds. The maximum iron loss difference (ΔW_{17/50} (W/kg)) between the stationary portion and the leading and tail ends of the obtained steel sheet was 0.013 W/kg (the leading and tail ends were inferior).

For comparison, cold rolling was performed at a constant strain rate of 58 s⁻¹ at 30° C. all along the length, and the maximum iron loss difference (ΔW_{17/50} (W/kg)) between the stationary portion and the leading and tail ends of the obtained steel sheet was determined as above. The result was 0.022 W/kg (the leading and tail ends were inferior).

### Example 2

A steel slab containing, in mass%, C: 0.04 %, Si: 3.1 %, Mn: 0.06 %, A1: 0.005 %, Cr: 0.01 %, P: 0.02 %, and S, Se and O each in a reduced amount of less than 50 ppm and N in a reduced amount of less than 40 ppm, with the balance being Fe and inevitable impurities, was heated to 1180° C., subjected to hot rolling to obtain a hot-rolled coil with a thickness of 2.0 mm, and then subjected to hot-rolled sheet annealing at 1050° C. for 60 seconds. Next, the obtained hot band-annealed sheet was rolled to 0.26 mm using a tandem mill (with a roll diameter of 280 mmφ and 4 stands) in which an induction heating device was placed immediately before the entry side of a first pass of the mill to obtain a cold-rolled sheet.

During the cold rolling, the strain rate and the biting temperature were changed as listed in Table 1 for the leading and tail ends and the stationary portion of the coil. The rolling reduction of the first stand (first pass) was 32 %.

The obtained cold-rolled sheet was subjected to primary recrystallization annealing under conditions of an average heating rate of 150° C. between 50° C. and 700° C., a soaking temperature of 800° C., and a soaking time of 50 seconds. Ten test pieces of 30 mm × 30 mm were cut from each of the stationary portion and the leading and tail ends of the sheet after primary recrystallization annealing, and the X-ray inverse intensity of the test pieces was measured.

Next, the sheet after primary recrystallization annealing was applied with an annealing separator mainly composed of MgO and subjected to secondary recrystallization annealing at a soaking temperature of 1200° C. for a soaking time of 5 hours.

The obtained sheet after secondary recrystallization annealing was applied with a coating solution containing phosphate-chromate-colloidal silica in a weight ratio of 3:1:2 and subjected to stress relief annealing at 800° C. for 3 hours. Next, ten test pieces of 30 mm × 280 mm were cut from each of the stationary portion and the leading and tail ends, and the iron loss W_{17/50} (W/kg) was measured with an Epstein test. The results are listed in Table 1.

TABLE 1

| Coil | Steel sheet temperature on entry side of first pass of rolling (°C) | | | Strain rate of first pass (s⁻¹) | | (110) Intensity after primary recrystallization | | | Product sheet W_{17/50}(W/kg) | | | Remarks |
|---|---|---|---|---|---|---|---|---|---|---|---|---|
| | Leading and tail ends | Stationary portion | Difference in temperature | Leading and tail ends | Stationary portion | Leading and tail ends | Stationary portion | Difference in intensity | Leading and tail ends | Stationary portion | Difference in magnetic property | |
| 1 | 60 | 60 | 0 | 62.7 | 62.7 | 0.71 | 0.89 | 0.18 | 0.855 | 0.836 | 0.019 | Comparative Example |
| 2 | 68 | 58 | 10 | 62.7 | 62.7 | 0.74 | 0.85 | 0.11 | 0.854 | 0.841 | 0.013 | Comparative Example |
| 3 | 70 | 60 | 10 | 62.7 | 62.7 | 0.78 | 0.87 | 0.09 | 0.848 | 0.838 | 0.010 | Example |
| 4 | 70 | 62 | 8 | 62.7 | 62.7 | 0.79 | 0.92 | 0.13 | 0.847 | 0.832 | 0.015 | Comparative Example |
| 5 | 80 | 60 | 20 | 62.7 | 81.6 | 0.83 | 0.85 | 0.02 | 0.847 | 0.841 | 0.006 | Example |
| 6 | 120 | 60 | 60 | 50.2 | 81.6 | 0.86 | 0.85 | 0.01 | 0.838 | 0.84 | 0.002 | Example |
| 7 | 50 | 50 | 0 | 112.9 | 112.9 | 0.49 | 0.66 | 0.17 | 0.877 | 0.856 | 0.021 | Comparative Example |
| 8 | 70 | 70 | 0 | 112.9 | 112.9 | 0.57 | 0.72 | 0.15 | 0.865 | 0.848 | 0.017 | Comparative Example |
| 9 | 80 | 70 | 10 | 112.9 | 112.9 | 0.68 | 0.74 | 0.06 | 0.857 | 0.846 | 0.011 | Example |
| 10 | 90 | 70 | 20 | 94.1 | 112.9 | 0.7 | 0.73 | 0.03 | 0.856 | 0.849 | 0.007 | Example |
| 11 | 120 | 70 | 50 | 81.6 | 112.9 | 0.72 | 0.74 | 0.02 | 0.85 | 0.848 | 0.002 | Example |
| 12 | 150 | 70 | 80 | 62.7 | 125.5 | 0.74 | 0.7 | 0.04 | 0.848 | 0.85 | 0.002 | Example |

As listed in Table 1, variations in texture within the coil were suppressed and differences in magnetic properties were small in Examples.

### Example 3

A steel slab containing the components listed in Table 2 was heated to 1200° C. and then subjected to hot rolling to obtain a hot-rolled coil with a thickness of 2.2 mm, and then the hot-rolled coil was subjected to hot-rolled sheet annealing at 950° C. for 30 seconds. Next, using a tandem mill (with a roll diameter of 280 mmφ and 4 stands), the coil was rolled to 0.22 mm to obtain a cold-rolled sheet.

During the cold rolling, the strain rate at the leading and tail ends and at the stationary portion of the coil was 62.7 s⁻¹ and 125.5 s⁻¹, respectively. Further, the biting temperature of the leading and tail ends and of the stationary portion of the coil was set to 120° C. and 70° C., respectively, by a heating device in which an induction heating coil was placed immediately before the entry side of a first pass of the mill.

The obtained cold-rolled sheet was subjected to primary recrystallization annealing under conditions of a heating rate of 250° C./s between 300° C. and 700° C., a soaking temperature of 850° C., and a soaking time of 40 seconds.

The obtained sheet after primary recrystallization annealing was applied with an annealing separator mainly composed of MgO and subjected to secondary recrystallization annealing at a soaking temperature of 1200° C. for a soaking time of 5 hours.

The obtained sheet after secondary recrystallization annealing was applied with a coating solution containing phosphate-chromate-colloidal silica in a weight ratio of 3:1:2 and subjected to flattening annealing at 850° C. for 30 seconds. Next, test pieces of 30 mm × 280 mm with a total weight of 500 g or more were cut from each of the stationary portion and the leading and tail ends, and the iron loss W_{17/50} (W/kg) was measured with an Epstein test. The results are listed in Table 2.

TABLE 2

| Steel* | Si (%) | C (%) | Mn (%) | Al (ppm) | S (ppm) | Se (ppm) | N (ppm) | Added element (%) | Product sheet W_{17/50}(W/kg) | | | Remarks |
|---|---|---|---|---|---|---|---|---|---|---|---|---|
| | | | | | | | | | Leading and tail ends | Stationary portion | Difference in magnetic property | |
| A | 3.34 | 0.03 | 0.05 | 70 | 30 | 5 | 40 | - | 0.852 | 0.853 | 0.001 | Example |
| B | 3.35 | 0.04 | 0.04 | 60 | 40 | 5 | 40 | Cr:0.03 Mo:0.02 | 0.846 | 0.844 | 0.002 | Example |
| C | 3.30 | 0.04 | 0.06 | 50 | 20 | 60 | 30 | Sb:0.03 | 0.845 | 0.847 | 0.002 | Example |
| D | 3.32 | 0.05 | 0.06 | 50 | 20 | 5 | 30 | Ni:0.02 | 0.844 | 0.846 | 0.002 | Example |
| E | 3.37 | 0.05 | 0.03 | 80 | 40 | 5 | 40 | Cu:0.02 Sn:0.01 | 0.844 | 0.842 | 0.002 | Example |
| F | 3.38 | 0.04 | 0.04 | 40 | 30 | 5 | 30 | Cr:0.04 P:0.01 Nb:0.002 | 0.835 | 0.838 | 0.003 | Example |
| G | 3.30 | 0.04 | 0.04 | 70 | 50 | 5 | 40 | B:0.001 | 0.849 | 0.848 | 0.001 | Example |
| H | 3.31 | 0.03 | 0.05 | 50 | 20 | 20 | 30 | P:0.06 Bi:0.001 | 0.844 | 0.842 | 0.002 | Example |

_{*}The amount of O in A to H is 50 ppm or less.

As listed in Table 2, similar iron loss improvement effects were observed in cases of using a steel slab containing additive elements.

1. A method of manufacturing a grain-oriented electrical steel sheet, comprising
preparing a steel slab comprising a chemical composition containing, in mass%, C: 0.01 % to 0.10 %,
Si: 2.0 % to 4.5 %,
Mn: 0.01 % to 0.5 %,
Al: less than 0.0100 %,
S: 0.0070 % or less,
Se: 0.0070 % or less,
N: 0.0050 % or less, and
O: 0.0050 % or less,
with the balance being Fe and inevitable impurities,
subjecting the steel slab to hot rolling to obtain a hot-rolled sheet, subjecting the hot-rolled sheet to annealing to obtain a hot-rolled and annealed sheet, subjecting the hot-rolled and annealed sheet to cold rolling once or twice or more with intermediate annealing performed therebetween to obtain a cold-rolled sheet with a final sheet thickness, and subjecting the cold-rolled sheet to primary recrystallization annealing and secondary recrystallization annealing, wherein
at least one time of cold rolling has a total rolling reduction of 80 % or more and is performed by a tandem mill,
rolling performed in at least one stand of the tandem mill is performed under conditions of a rolling reduction of 30 % or more and a biting temperature T₀ °C of a work roll of the stand, and
a temperature at which either or both of a leading end and a tail end of the hot-rolled and annealed sheet are bitten by the work roll is 70° C. or higher and at least 10° C. higher than the T₀ °C.

2. The method of manufacturing a grain-oriented electrical steel sheet according to claim 1, wherein a temperature at which either or both of a leading end and a tail end of the hot-rolled and annealed sheet are bitten by the work roll is 120° C. or higher and at least 20° C. higher than the T₀ °C.

3. The method of manufacturing a grain-oriented electrical steel sheet according to claim 1, wherein the at least one stand is a first stand of the tandem mill.

4. The method of manufacturing a grain-oriented electrical steel sheet according to claim 1, wherein rolling performed in at least one stand of the tandem mill is performed at a strain rate of 65 s⁻¹ or more, and either or both of a leading end and a tail end of the hot-rolled and annealed sheet are rolled at a strain rate of less than 65 s⁻¹.

5. The method of manufacturing a grain-oriented electrical steel sheet according to claim 1, wherein the steel slab further contains, in mass%, at least one selected from the group consisting of
Ni: 0.005 % to 1.50 %,
Sn: 0.01 % to 0.50 %,
Sb: 0.005 % to 0.50 %,
Cu: 0.01 % to 0.50 %,
Mo: 0.01 % to 0.50 %,
P: 0.0050 % to 0.50 %,
Cr: 0.01 % to 1.50 %,
Nb: 0.0005 % to 0.0200 %,
B: 0.0005 % to 0.0200 %, and
Bi: 0.0005 % to 0.0200 %.

6. A manufacturing line comprising a heating device and a tandem mill, wherein
the manufacturing line further comprises a detection device that detects a position in a longitudinal direction of a steel sheet and a control unit of the heating device, and
the control unit controls the heating device based on an output from the detection device to adjust a biting temperature of a work roll of at least one stand of the tandem mill.

7. The manufacturing line according to claim 6, wherein the heating device utilizes any one of induction heating, electrical resistance heating, or infrared heating.

8. The method of manufacturing a grain-oriented electrical steel sheet according to claim 2, wherein the steel slab further contains, in mass%, at least one selected from the group consisting of
Ni: 0.005 % to 1.50 %,
Sn: 0.01 % to 0.50 %,
Sb: 0.005 % to 0.50 %,
Cu: 0.01 % to 0.50 %,
Mo: 0.01 % to 0.50 %,
P: 0.0050 % to 0.50 %,
Cr: 0.01 % to 1.50 %,
Nb: 0.0005 % to 0.0200 %,
B: 0.0005 % to 0.0200 %, and
Bi: 0.0005 % to 0.0200 %.

9. The method of manufacturing a grain-oriented electrical steel sheet according to claim 3, wherein the steel slab further contains, in mass%, at least one selected from the group consisting of
Ni: 0.005 % to 1.50 %,
Sn: 0.01 % to 0.50 %,
Sb: 0.005 % to 0.50 %,
Cu: 0.01 % to 0.50 %,
Mo: 0.01 % to 0.50 %,
P: 0.0050 % to 0.50 %,
Cr: 0.01 % to 1.50 %,
Nb: 0.0005 % to 0.0200 %,
B: 0.0005 % to 0.0200 %, and
Bi: 0.0005 % to 0.0200 %.

10. The method of manufacturing a grain-oriented electrical steel sheet according to claim 4, wherein the steel slab further contains, in mass%, at least one selected from the group consisting of
Ni: 0.005 % to 1.50 %,
Sn: 0.01 % to 0.50 %,
Sb: 0.005 % to 0.50 %,
Cu: 0.01 % to 0.50 %,
Mo: 0.01 % to 0.50 %,
P: 0.0050 % to 0.50 %,
Cr: 0.01 % to 1.50 %,
Nb: 0.0005 % to 0.0200 %,
B: 0.0005 % to 0.0200 %, and
Bi: 0.0005 % to 0.0200 %.
